(19) United States
(12) Patent Application Publication
(10) Pub. No.: US 2023/0189217 A1
(43) Pub. Date: Jun. 15, 2023

(54) SIDELINK COMMUNICATION IN FLEXIBLE SLOT

(71) Applicant: QUALCOMM Incorporated, San Diego, CA (US)

(72) Inventors: Hua WANG, Basking Ridge, NJ (US); Sony AKKARAKARAN, Poway, CA (US); Tao LUO, San Diego, CA (US); Junyi LI, Fairless Hills, PA (US); Jelena DAMNJANOVIC, Del Mar, CA (US); Peter GAAL, San Diego, CA (US); Juan MONTOJO, San Diego, CA (US); Jung Ho RYU, Fort Lee, NJ (US)

(21) Appl. No.: 17/644,263

(22) Filed: Dec. 14, 2021

(51) Int. Cl. H04W 72/02; H04W 72/04; H04W 72/10

(52) U.S. Cl. CPC H04W 72/02; H04W 72/10; H04W 72/042; H04W 72/0446

(57) ABSTRACT

Various aspects of the present disclosure generally relate to wireless communication. In some aspects, a user equipment (UE) may receive an indication regarding a set of slots, wherein the indication indicates one or more flexible slots, of the set of slots, that are available for both downlink communication and uplink communication. The UE may receive a configuration of a resource pool including the one or more flexible slots. The UE may perform a sidelink communication in accordance with the configuration. Numerous other aspects are described.

### FIELD OF THE DISCLOSURE

Aspects of the present disclosure generally relate to wireless communication and to techniques and apparatuses for performing sidelink communication in a flexible slot.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating an example of sidelink communications and access link communications, in accordance with the present disclosure.

FIG. 4 is a diagram illustrating an example of sidelink communications, in accordance with the present disclosure.

FIG. 5 is a diagram illustrating an example of a sidelink resource pool, in accordance with the present disclosure.

FIG. 6 is a diagram illustrating an example of a slot format used to schedule UE communications, in accordance with the present disclosure.

FIG. 7 is a diagram illustrating an example of sidelink resources potentially available for inclusion in a sidelink resource pool, in accordance with the present disclosure.

FIG. 8 is a diagram illustrating an example of a signaling scheme for configuring a slot format, in accordance with the present disclosure.

FIG. 9 is a diagram illustrating an example process performed, for example, by a UE, in accordance with the present disclosure.

FIG. 10 is a diagram illustrating an example process performed, for example, by a base station, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### SUMMARY

Some aspects described herein relate to a method of wireless communication performed by a UE. The method may include receiving an indication regarding a set of slots, wherein the indication indicates one or more flexible slots, of the set of slots, that are available for both downlink communication and uplink communication. The method may include receiving a configuration of a resource pool including the one or more flexible slots. The method may include performing a sidelink communication in accordance with the configuration.

Some aspects described herein relate to a method of wireless communication performed by a base station. The method may include transmitting, to a UE, an indication regarding a set of slots, wherein the indication indicates one or more flexible slots, of the set of slots, that are available for both downlink communication and uplink communication. The method may include transmitting, to the UE, a configuration of a resource pool including the one or more flexible slots, the resource pool identifying resources available for use by the UE to perform a sidelink communication.

Some aspects described herein relate to an apparatus for wireless communication at a UE. The apparatus may include a memory and one or more processors coupled to the memory. The one or more processors may be configured to receive an indication regarding a set of slots, wherein the indication indicates one or more flexible slots, of the set of slots, that are available for both downlink communication and uplink communication. The one or more processors may be configured to receive a configuration of a resource pool including the one or more flexible slots. The one or more processors may be configured to perform a sidelink communication in accordance with the configuration.

Some aspects described herein relate to an apparatus for wireless communication at a base station. The apparatus may include a memory and one or more processors coupled to the memory. The one or more processors may be configured to transmit, to a UE, an indication regarding a set of slots, wherein the indication indicates one or more flexible slots, of the set of slots, that are available for both downlink communication and uplink communication. The one or more processors may be configured to transmit, to the UE, a configuration of a resource pool including the one or more flexible slots, the resource pool identifying resources available for use by the UE to perform a sidelink communication.

Some aspects described herein relate to a non-transitory computer-readable medium that stores a set of instructions for wireless communication by a UE. The set of instructions, when executed by one or more processors of the UE, may cause the UE to receive an indication regarding a set of slots, wherein the indication indicates one or more flexible slots, of the set of slots, that are available for both downlink communication and uplink communication. The set of instructions, when executed by one or more processors of the UE, may cause the UE to receive a configuration of a resource pool including the one or more flexible slots. The set of instructions, when executed by one or more processors of the UE, may cause the UE to perform a sidelink communication in accordance with the configuration.

Some aspects described herein relate to a non-transitory computer-readable medium that stores a set of instructions for wireless communication by a base station. The set of instructions, when executed by one or more processors of the base station, may cause the base station to transmit, to a UE, an indication regarding a set of slots, wherein the indication indicates one or more flexible slots, of the set of slots, that are available for both downlink communication and uplink communication. The set of instructions, when executed by one or more processors of the base station, may cause the base station to transmit, to the UE, a configuration of a resource pool including the one or more flexible slots, the resource pool identifying resources available for use by the UE to perform a sidelink communication.

Some aspects described herein relate to an apparatus for wireless communication. The apparatus may include means for receiving an indication regarding a set of slots, wherein the indication indicates one or more flexible slots, of the set of slots, that are available for both downlink communication and uplink communication. The apparatus may include means for receiving a configuration of a resource pool including the one or more flexible slots. The apparatus may include means for performing a sidelink communication in accordance with the configuration.

Some aspects described herein relate to an apparatus for wireless communication. The apparatus may include means for transmitting, to a UE, an indication regarding a set of slots, wherein the indication indicates one or more flexible slots, of the set of slots, that are available for both downlink communication and uplink communication. The apparatus may include means for transmitting, to the UE, a configuration of a resource pool including the one or more flexible slots, the resource pool identifying resources available for use by the UE to perform a sidelink communication.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

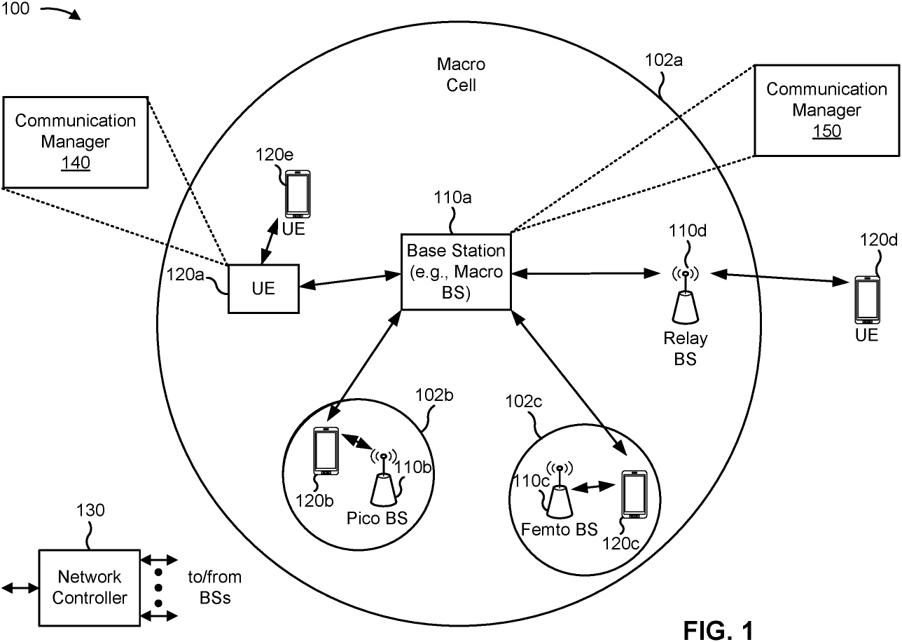

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a UE 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart j ewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz - 7.125 GHz) and FR2 (24.25 GHz - 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz - 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz - 71 GHz), FR4 (52.6 GHz - 114.25 GHz), and FR5 (114.25 GHz - 300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication regarding a set of slots, wherein the indication indicates one or more flexible slots, of the set of slots, that are available for both downlink communication and uplink communication; receive a configuration of a resource pool including the one or more flexible slots; and perform a sidelink communication in accordance with the configuration. Additionally, or alternatively, the communication manager 140 may perform one or more other operations described herein.

In some aspects, the base station 110 may include a communication manager 150. As described in more detail elsewhere herein, the communication manager 150 may transmit, to a UE, an indication regarding a set of slots, wherein the indication indicates one or more flexible slots, of the set of slots, that are available for both downlink communication and uplink communication; and transmit, to the UE, a configuration of a resource pool including the one or more flexible slots, the resource pool identifying resources available for use by the UE to perform a sidelink communication. Additionally, or alternatively, the communication manager 150 may perform one or more other operations described herein.

As indicated above, FIG. 1 is provided as an example. Other examples may differ from what is described with regard to FIG. 1.

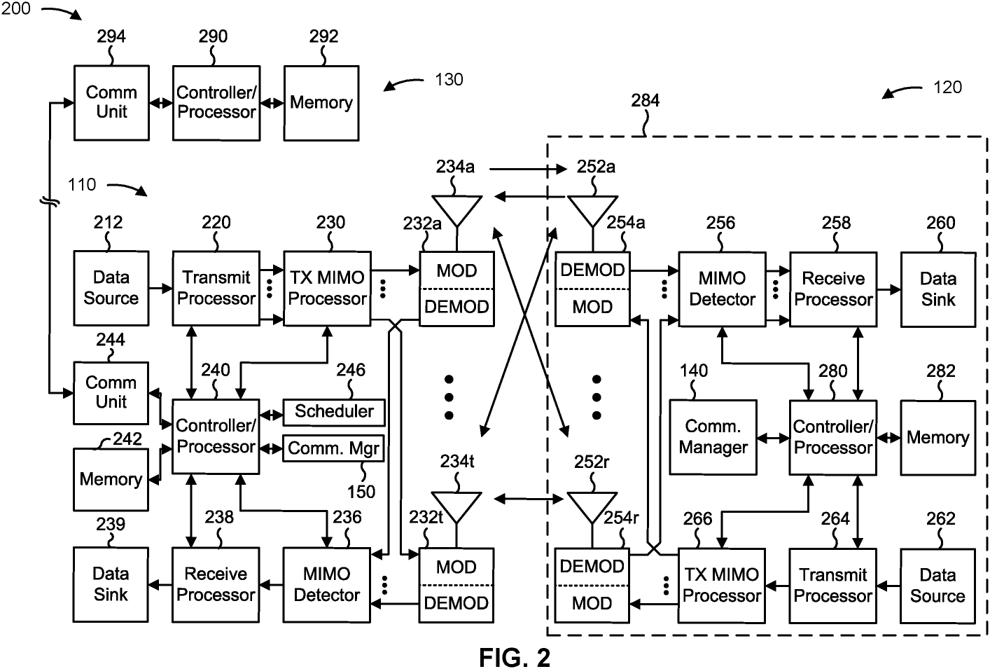

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T ≥ 1). The UE 120 may be equipped with a set of antennas 252a through 252r, such as R antennas (R ≥ 1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

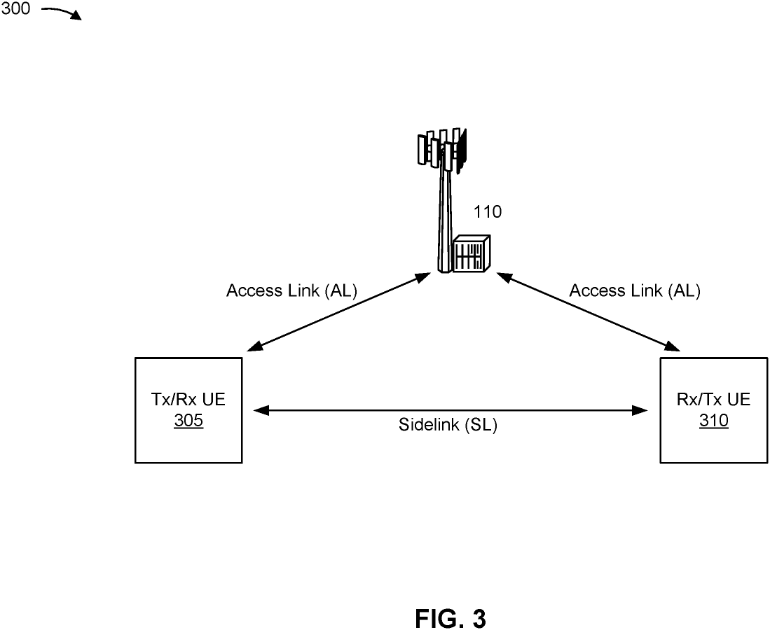

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-12).

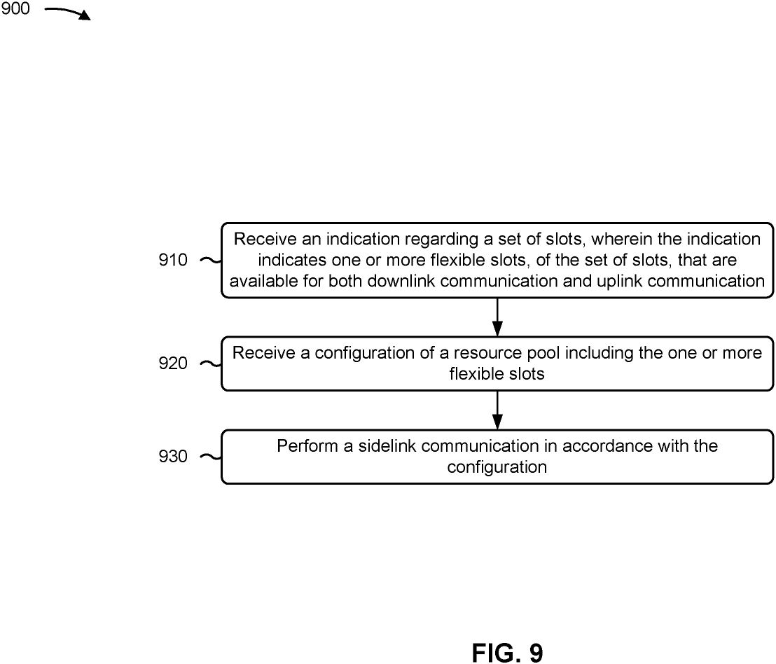

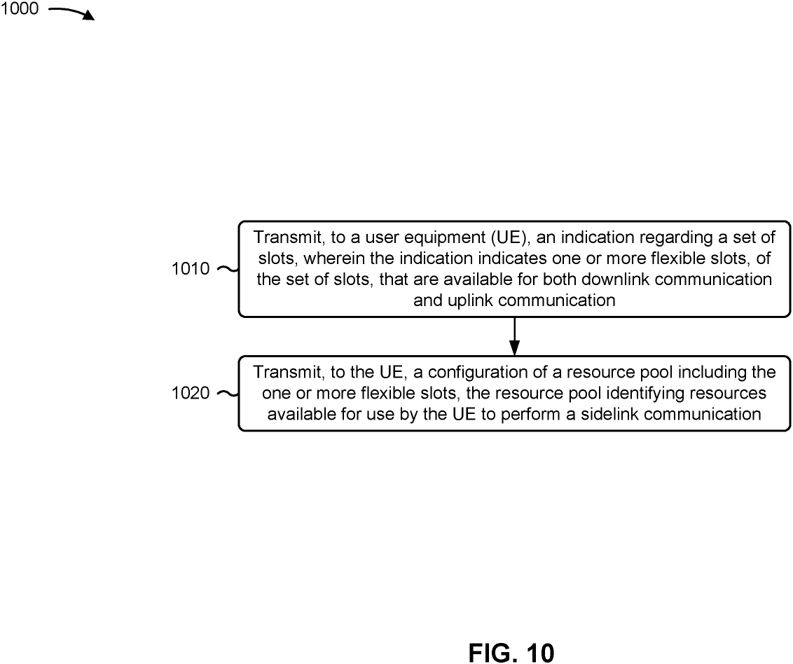

The controller/processor 240 of the base station 110, the controller/processor 280 of the UE 120, and/or any other component(s) of FIG. 2 may perform one or more techniques associated with performing sidelink communication in a flexible slot, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving an indication regarding a set of slots, wherein the indication indicates one or more flexible slots, of the set of slots, that are available for both downlink communication and uplink communication; means for receiving a configuration of a resource pool including the one or more flexible slots; and/or means for performing a sidelink communication in accordance with the configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a UE 120, an indication regarding a set of slots, wherein the indication indicates one or more flexible slots, of the set of slots, that are available for both downlink communication and uplink communication; and/or means for transmitting, to the UE 120, a configuration of a resource pool including the one or more flexible slots, the resource pool identifying resources available for use by the UE to perform a sidelink communication. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of sidelink communications and access link communications, in accordance with the present disclosure.

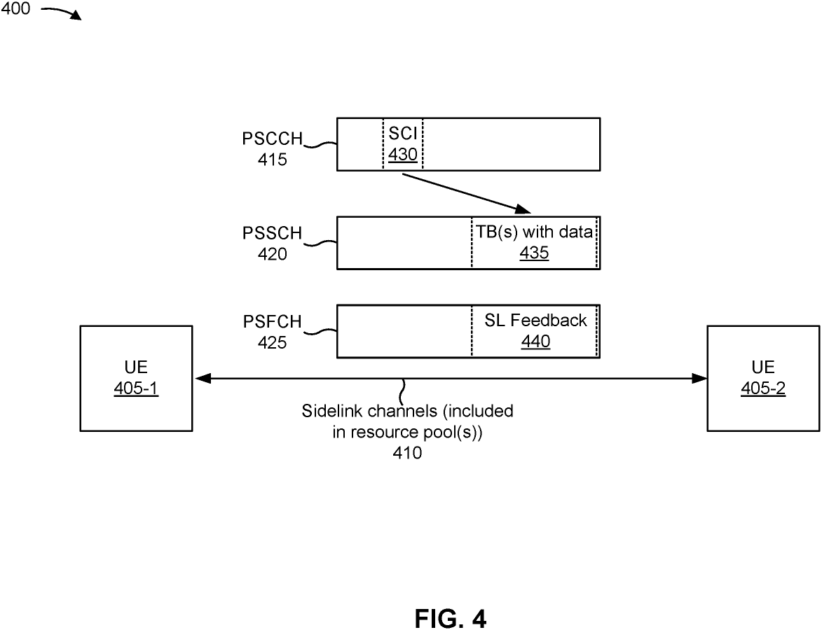

As shown in FIG. 3, a transmitter (Tx)/receiver (Rx) UE 305 and an Rx/Tx UE 310 may communicate with one another via a sidelink, as described in more detail in connection with FIG. 4. As further shown, in some sidelink modes, a base station 110 may communicate with the Tx/Rx UE 305 via a first access link. Additionally, or alternatively, in some sidelink modes, the base station 110 may communicate with the Rx/Tx UE 310 via a second access link. The Tx/Rx UE 305 and/or the Rx/Tx UE 310 may correspond to one or more UEs described elsewhere herein, such as the UE 120 of FIG. 1. A direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

Some techniques described herein provide for semi-static or dynamic signaling to indicate slots that are available for communication via the sidelink, which increases the number of slots that are available for communication via the sidelink, thereby increasing flexibility of slot configuration.

As indicated above, FIG. 3 is provided as an example. Other examples may differ from what is described with respect to FIG. 3.

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a base station 110 via an access link or an access channel. The PSSCH 420 may be used to communicate data, similar to a physical downlink shared channel (PDSCH) and/or a physical uplink shared channel (PUSCH) used for cellular communications with a base station 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACKNACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some aspects, a UE 405 may operate using a sidelink transmission mode (e.g., Mode 1) where resource selection and/or scheduling is performed by a base station 110. For example, the UE 405 may receive a grant (e.g., in downlink control information (DCI) or in a radio resource control (RRC) message, such as for configured grants) from the base station 110 for sidelink channel access and/or scheduling. In some aspects, a UE 405 may operate using a transmission mode (e.g., Mode 2) where resource selection and/or scheduling is performed by the UE 405 (e.g., rather than a base station 110). In some aspects, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy rate (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As shown, the one or more sidelink channels 410 may be included in one or more resource pools. A resource pool (sometimes referred to as a sidelink resource pool) is a set of resources configured for (e.g., assigned for) sidelink communication. A sidelink resource pool may be configured via semi-static (e.g., radio resource control (RRC)) signaling. A resource pool may be configured to include particular time resources (e.g., slots) and a particular set of contiguous frequency resources (e.g., resource blocks). A resource pool (e.g., the arrangement of time resources included in the resource pool) may periodically repeat. According to some techniques described herein, the resource pool may include one or more flexible time resources reserved for uplink communication or downlink communication, one or more flexible time resources thereafter reconfigured to be used for uplink communication, and/or one or more sidelink-specific time resources reserved for sidelink communication, thereby increasing the amount of resources available for sidelink communication.

As indicated above, FIG. 4 is provided as an example. Other examples may differ from what is described with respect to FIG. 4.

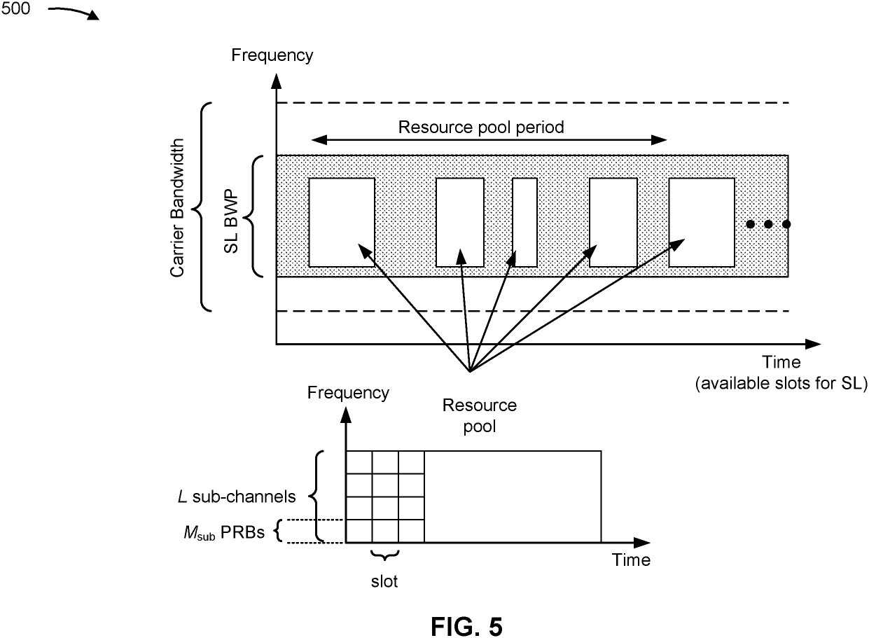

FIG. 5 is a diagram illustrating an example 500 of a sidelink resource pool, in accordance with the present disclosure.

For communications using an orthogonal frequency division multiplexing (OFDM) waveform with a cyclic prefix (CP), the contiguous set of time resources in which a UE may transmit or receive a communication is provided in a frame structure organized into radio frames, subframes, slots, and symbols. The frame structure repeats according to a given periodicity. Each radio frame has a given duration (e.g., 10 ms), with each radio frame further divided into a number of subframes (e.g., 10 subframes), each with a given duration (e.g., 1 ms). For 5G NR communications, the number of slots included in each subframe is flexible and varies according to the numerology used for transmission, with each subframe including 2^{m} slots, where m is a numerology used for transmission. A numerology may be identified by an index, such as 0, 1, 2, 3, 4, and so on. The numerology may indicate a subcarrier spacing (SCS) and a CP length of a carrier or bandwidth part. Each slot includes a number of OFDM symbols (e.g., 14 OFDM symbols). A subset of the slots may be configured for use by the UE during sidelink communication.

Similarly, a portion of the total frequency resources available to the UE may be available for sidelink communication. The portion of the total frequency resources available for sidelink communication is a continuous portion of bandwidth within a carrier, known as a sidelink bandwidth part (SL BWP). The SL BWP is divided into resource blocks (RBs), with each RB including a number (e.g., twelve) of consecutive subcarriers having the same SCS, governed by the numerology of the SL BWP. Thus, the resources potentially available for sidelink communication include slots that are allocated for sidelink communication (time resources) and RBs within a SL BWP (frequency resources).

As shown in FIG. 5, the resource pool is a subset of these potentially available sidelink resources that are specifically configured to be used by a UE for sidelink communication. The common RBs within the resource pool are referred to as physical resource blocks (PRBs). As shown, the resource pool includes contiguous PRBs, but may include contiguous or non-contiguous slots. The resource pool is divided into a configured number L of contiguous sub-channels, each including a group of consecutive PRBs in a slot. More particularly, each sub-channel includes M_{sub} number of PRBs, where M_{sub} is a configured parameter for the resource pool, and in some aspects may be equal to 10, 12, 15, 20, 25, 50, 75, or 100 PRBs. A sidelink communication may use one or more sub-channels for transmission or reception. There are rules specifying which slots can be included in a resource pool, such as based at least in part on a time division duplexing slot format of such slots, as described in more detail elsewhere herein.

As indicated above, FIG. 5 is provided as an example. Other examples may differ from what is described with respect to FIG. 5.

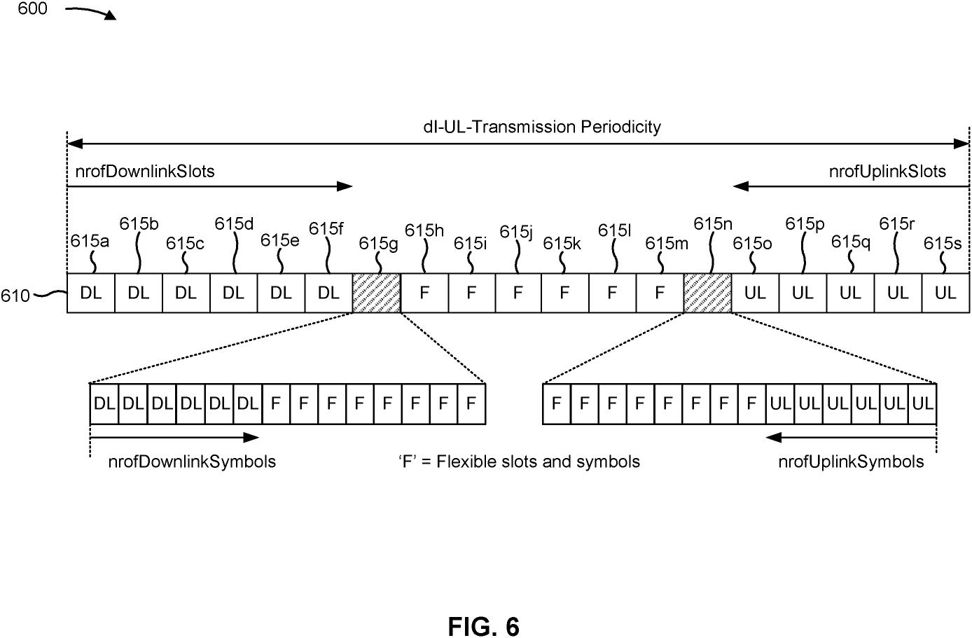

FIG. 6 is a diagram illustrating an example 600 of a slot format used to schedule UE communications, in accordance with the present disclosure. As described above, a transmission timeline may be organized into radio frames, subframes, slots, and symbols. However, for ease of description, only the slot and symbol granularity are depicted in FIG. 6. Example 600 shows how time division duplexed (TDD) slots (e.g., slots on a TDD carrier) can be configured as usable for uplink and/or downlink communication using a combination of semi-static and dynamic signaling.

A timeline of slots is shown by reference number 610, which includes a number of slots 615a-615s. Each slot 615 and/or portions thereof (e.g., symbols) may be scheduled and/or configured for use for an uplink (“UL”) communication, a downlink (“DL”) communication, or as flexible (“F”). A flexible slot (e.g., 615h-615m) may be used for either an uplink communication or a downlink communication. All symbols within each slot may all be assigned alike (e.g., all “UL,” all “DL,” or all “F”), or else the slot may include multiple symbol assignment types. For example, in FIG. 6, slots 615a-615f (denoted by “nrofDownlinkSlots”) are depicted as downlink slots without showing the symbol granularity because all symbols in each of those slots are configured as downlink symbols. Similarly, slots 615o-615s (denoted by “nrofUplinkSlots”) are depicted as uplink slots without showing the symbol granularity because all symbols in each of those slots are configured as uplink symbols. In this regard, “nrofDownlinkSlots” refers to the number of consecutive full DL slots (e.g., slots including only DL symbols) at the beginning of each timeline of slots 610 (e.g., slots 615a-615f), and “nrofUplinkSlots” refers to the number of consecutive full UL slots (e.g., slots including only UL symbols) at the end of each timeline of slots 610 (e.g., slots 615o-615s).

Slots 615g and 615n include more than one format of symbols. More particularly, slot 615g includes six downlink symbols (denoted by “nrofDownlinkSymbols”), with the remaining eight symbols being flexible and thus available for uplink or downlink, for a total of fourteen symbols. Slot 615n includes six uplink symbols (denoted by “nrojUplinkSymbols”), with the remaining eight symbols being flexible and thus available for uplink or downlink, again for a total of fourteen symbols. In this regard, “nrofDownlinkSymbols” refers to the number of consecutive DL symbols in the beginning of the slot 615g following the last full DL slot 615f, and “nrofUplinkSymbols” refers to the number of consecutive UL symbols in the end of the slot 615n preceding the first full UL slot 615ₒ. The remaining slots in the timeline of slots 610 (e.g., slots 615h-615m) are flexible (e.g., full flexible, with all symbols in these slots being configured as flexible symbols), and thus available for uplink and downlink communication.

Slots and/or symbols semi-statically configured as flexible may be later reconfigured for use for uplink or downlink communication. In some aspects, a common configuration parameter (e.g., tdd-UL-DL-ConfigurationCommon or similar) transmitted to all UEs in a cell defines a semi-static slot and/or symbol structure, including designating certain slots or symbols for use in uplink communication, downlink communication, or as flexible for use in either uplink or downlink communication. For example, the common configuration parameter may semi-statically configure slots and symbols to have an initial configuration as shown in FIG. 6. A dedicated configuration parameter (e.g., tdd-UL-DL-ConfigurationDedicated), which can be transmitted to a specific UE, may then be used to reconfigure the flexible slots and symbols as uplink or downlink slots and symbols. In some cases, for a remaining flexible slot or symbol (e.g., slots or symbols still configured as flexible after the reconfiguration due to the dedicated configuration parameter), the UE may monitor for physical downlink control channel (PDCCH) information, and determine whether a flexible slot or symbol should be configured as an uplink slot or symbol or a downlink slot or symbol based at least in part on an uplink and/or downlink resource allocation indicated by the PDCCH information. In some cases, the flexible slots or symbols may be dynamically changed by the base station via a DCI message or a similar message.

As mentioned above, UEs may communicate with one another on the sidelink using sidelink resource pools. Traditionally, only slots reserved for uplink communication via the common configuration parameter are permitted to be included in a sidelink resource pool. More particularly, a sidelink resource pool could not include slots that do not include a number of contiguous OFDM symbols that are semi-statically configured as uplink symbols by a common configuration parameter provided in an RRC message or a similar message. In the depicted example 600, only slots 615o-615s and potentially slot 615n could thus be used for sidelink communication (slot 615n includes six contiguous UL symbols, and would be available for sidelink communication if the configured sidelink parameters required six or less contiguous uplink symbols, beginning at the ninth symbol in the slot, for inclusion of the corresponding slot in the resource pool). In that regard, a slot that was initially configured by the common configuration parameter as flexible would be unavailable for sidelink communication even if the slot is later reconfigured (via the dedicated configuration parameter or the DCI) as an uplink slot. Using only slots that are commonly configured to include a number of contiguous uplink symbols for sidelink communication limits the resources available in which to perform sidelink communication and constrains flexibility in determining slot configurations, such as in response to changing network conditions. This results in reduced throughput, increased transmission time, and increased network congestion. This is particularly problematic for delay-sensitive applications, in which it is beneficial for UEs to send a sidelink communication as soon as the data to be transmitted is ready. Using only commonly configured uplink slots for sidelink communication also results in an inefficient allocation of time and/or frequency resources, particularly when there are slots that are excluded from use for sidelink communication even though they are not actively being used for uplink or downlink communication.

Some techniques and apparatuses described herein increase the number of potential resources to be included in a sidelink resource pool. More particularly, in some aspects, a resource pool may be allowed or configured to include time resources in addition to or instead of the commonly configured uplink slots previously available for sidelink communication. For example, in some aspects, a resource pool may include a slot that is semi-statically or dynamically configured as a flexible slot. In this context, “flexible slot” is used to mean a slot that is available for uplink and downlink communication. In some aspects, a slot is considered to be available for uplink and downlink communication (e.g., a slot is considered to be a flexible slot) even if the slot includes some symbols configured other than flexible, so long as the slot includes at least a configured number of contiguous OFDM symbols configured as flexible symbols. Additionally, or alternatively, a resource pool may include a slot that is commonly configured as a flexible slot but is reconfigured as an uplink slot (referred to herein as a “reconfigured uplink slot”), that is, a slot that is reconfigured to include at least a number of contiguous OFDM symbols configured as uplink symbols. Additionally, or alternatively, a resource pool may include a slot that is configured as a sidelink-specific slot, that is, a slot that includes at least a number of contiguous OFDM symbols configured as sidelink-specific symbols by a configuration parameter. As a result, time resources that are available to be used to perform sidelink communication are increased, thus increasing throughput, reducing sidelink transmission time, reducing network congestion, and providing for an efficient allocation of time and/or frequency resources.

As indicated above, FIG. 6 is provided as an example. Other examples may differ from what is described with regard to FIG. 6.

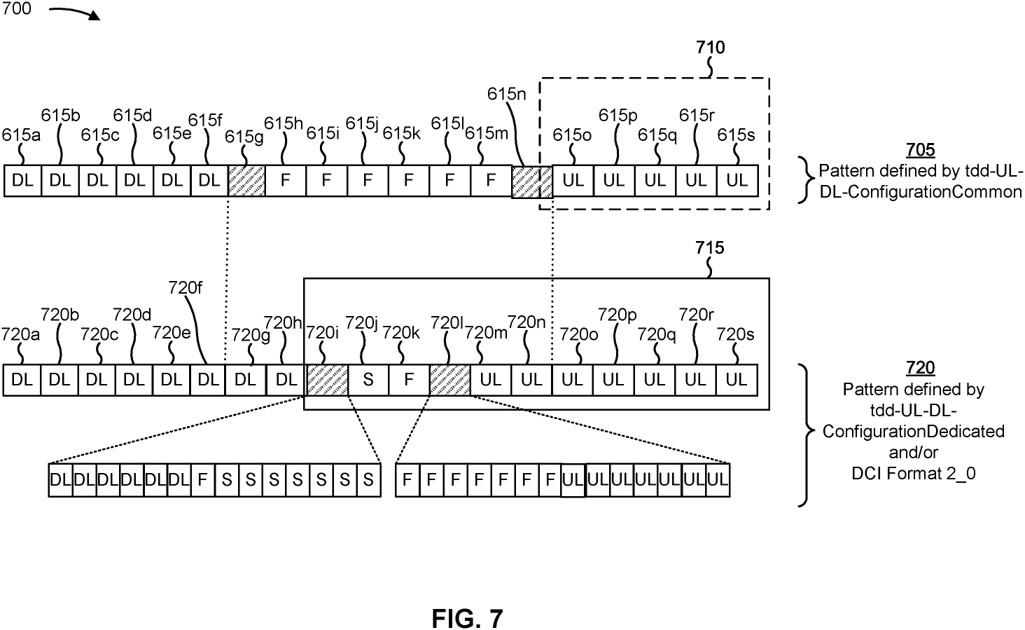

FIG. 7 is a diagram illustrating an example 700 of sidelink resources potentially available for inclusion in a sidelink resource pool, in accordance with the present disclosure. As schematically depicted in FIG. 7, the number of potential resources available for inclusion in a sidelink resource pool increases because, in addition to commonly configured uplink slots traditionally available for sidelink communication, flexible slots, reconfigured uplink slots, and sidelink-specific slots are all available for inclusion in the resource pool.

More particularly, a slot may be available for inclusion in the resource pool if the slot includes Y-th, (Y+1)-th, ..., (Y+X-1)-th OFDM symbols configured as flexible symbols, uplink symbols, or sidelink-specific symbols, wherein Y refers to a configured sidelink start symbol parameter (e.g., sl-StartSymbol) and X refers to a sidelink length symbol parameter (e.g., sl-LengthSymbol). For purposes of the depicted example 700, it is assumed that the configured sidelink start symbol parameter (e.g., sl-StartSymbol) indicates the eighth symbol in each slot as the starting symbol, and that sidelink length symbol parameter (e.g., sl-LengthSymbol) indicates for a minimum of seven consecutive symbols to be available for sidelink communication. These are merely example configurations for purposes of the following description, and in other aspects the sidelink start symbol parameter and the sidelink length symbol parameter may vary from these example configurations without departing from the scope of the present disclosure.

In FIG. 7, the top frame pattern 705 includes a set of slots (e.g., slots 615a-615s) having the same pattern as that provided in the timeline of slots 610 shown in FIG. 6 (e.g., the commonly configured frame structure, configured according to tdd-UL-DL-ConfigurationCommon), and a first group of resources 710 are resources that would have been available for inclusion in a sidelink resource pool for traditional sidelink communications. More particularly, and by a comparison of FIG. 7 with FIG. 6, only five slots could have potentially been included in a sidelink resource pool (e.g., slots 615o-615s, enclosed by the dashed border around the first group of resources 710) because those are the only slots that satisfy the condition that the slot includes a number of contiguous OFDM symbols (here, assumed to be seven consecutive symbols, beginning at the eighth symbol in the slot, for purposes of the example) that are semi-statically configured as uplink symbols by a common configuration parameter. Thus, for traditional sidelink communication configurations, only the first group of resources 710 (e.g., slots 615o-615s) could be ultimately included in the sidelink resource pool.

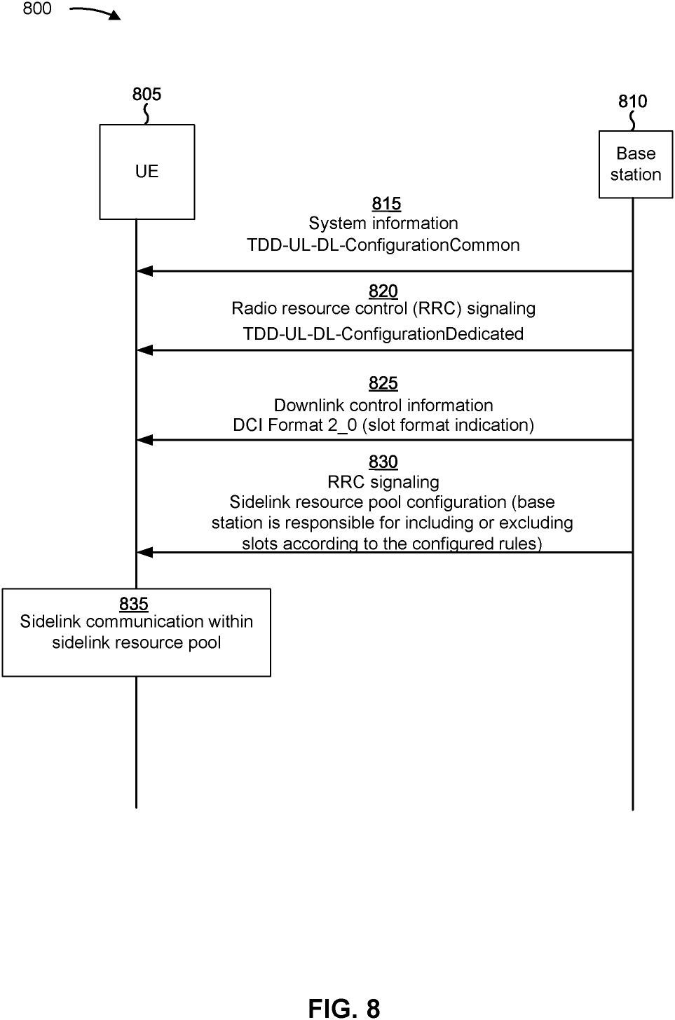

The bottom frame pattern 720 is the frame pattern 705 following reconfiguration (e.g., by RRC or DCI signaling), which is described in more detail in connection with FIG. 8, below. In the depicted example, the frame pattern 705 has been reconfigured to replace the slot format of 615g-615n with the slot formats 720g-720n. The slot formats for the remaining slots remain the same (e.g., slots 720a-720f have the same format as slots 615a-615f, and slots 720o-720s have the same format as slots 615o-615s). A second group of resources 715 illustrates an expanded group of resources available for inclusion in the sidelink resource pool following reconfiguration from the frame pattern 705 to the frame pattern 720 and in accordance with aspects of the disclosure.

Namely, and continuing under the assumption that the sidelink start symbol parameter is configured to point to the eighth symbol in each slot as the starting symbol, and that the sidelink length symbol parameter is configured to require seven consecutive symbols to be available for sidelink communication, the second group of resources 715 now includes eleven potential slots available for inclusion in the sidelink resource pool (e.g., slots 720i-720s). This is because, following semi-static and/or dynamic configuring (which will be discussed in more detail below), eight of the slots (e.g., slots 720l-720s) include at least seven consecutive uplink symbols beginning at the eighth symbol in the slot, one of the slots (e.g., slot 720k) includes at least seven consecutive flexible symbols beginning at the eighth symbol in the slot, and two of the slots (e.g., slots 720i and 720j) include at least seven consecutive sidelink-specific symbols beginning at the eighth symbol in the slot.

More particularly, the slots 720m-720s are configured as full uplink slots (e.g., slots including only UL symbols), and slot 720l immediately preceding slots 720m-720s has been reconfigured to include both F symbols and UL symbols. Furthermore, as reconfigured, the slot 720l includes seven consecutive UL symbols (in accordance with the sidelink length symbol parameter) beginning at the eighth symbol in the slot (in accordance with the sidelink start symbol parameter). Thus, slots 720l-720s are available for inclusion in the sidelink resource pool as either a commonly configured uplink slot (e.g., slots 720o-720s) or as a reconfigured uplink slot (e.g., slots 720l-720n).

Moreover, two of the slots (e.g., slots 720j and 720k) have been reconfigured such that slot 720j is a full sidelink-specific slot (e.g., the slot includes all S symbols) and slot 720k is a full flexible slot (e.g., the slot includes all F symbols), respectively. Thus, slots 720j and 720k are available for inclusion in the sidelink resource pool as a configured sidelink-specific slot and a configured flexible slot, respectively.

Still more, slot 720i (e.g., the slot immediately following the eight full downlink slots 720a-720h and immediately preceding the full sidelink-specific slot 720j) has been reconfigured to include seven consecutive sidelink-specific symbols (denoted with an “S”), beginning at the eighth symbol in the slot. Thus, slots 720i is available for inclusion in the sidelink resource pool as a sidelink-specific slot. Similarly, if the final seven symbols of slot 720i had been configured as flexible (e.g., denoted with an “F”), the slot would have been available for inclusion in the sidelink resource pool as a flexible slot.

In this way, techniques described herein increase the number of potential slots available for inclusion in the sidelink resource pool (e.g., for the example parameters used for the above description, from five slots, as shown by the first group of resources 710, to eleven slots, as shown by the second set of resources 715). This beneficially increases time resources that are available to be used to perform sidelink communication, thus increasing sidelink throughput, reducing sidelink transmission time, reducing network congestion, and providing for an efficient allocation of time and/or frequency resources.

As indicated above, FIG. 7 is provided as an example. Other examples may differ from what is described with regard to FIG. 7.

FIG. 8 is a diagram illustrating an example 800 of a signaling scheme for configuring a slot format, in accordance with the present disclosure. More particularly, FIG. 8 conceptually illustrates various signaling performed by a base station 810 to configure time and/or frequency resources to be used by a UE 805 for uplink, downlink, and/or sidelink communication. The base station 810 may correspond to any of the base stations previously described (e.g., base station 110), and the UE 805 may correspond to any of the UEs previously described (e.g., UEs 120, 305, 310, 405).

The base station 810 may provide certain indications, parameters, and/or configurations to the UE 805 via semi-static or dynamic signaling. For example, the base station 810 may provide indications, parameters, and/or configurations to the UE 805 via system information signaling 815. In some aspects, the system information signaling 815 may be provided via RRC signaling, such as in a system information block (SIB) or another RRC message (e.g., an RRC configuration message or an RRC reconfiguration message). In some aspects, the system information signaling 815 may be provided to all UEs 805 within a cell and may contain, among other information, an indication regarding a set of slots (e.g., slots 615a-615s, slots 720a-720s, or similar). In some aspects, the indication may be included in a common configuration parameter (e.g., an RRC parameter tdd-UL-DL-ConfigurationCommon), and/or may indicate a slot assignment for each slot within a frame structure. By way of example, the indication may indicate the slot format shown by frame pattern 705 in FIG. 7, and thus may indicate that the set of slots includes one or more uplink slots (e.g., slots 615o-615s) used for uplink communication, one or more downlink slots (e.g., slots 615a-615f) used for downlink communication, and/or one or more flexible slots (e.g., slots 615h-615m) that are available for uplink communication and downlink communication. In some aspects, the indication may indicate that certain slots, of the set of slots, include more than one type of symbol (e.g., the slot includes two or more of uplink, downlink, and symbols). For example, the indication may indicate that slot 615g should include six DL symbols followed by eight F symbols, and that the slot 615n should include eight F symbols followed by six UL symbols (as shown in FIG. 6). As described above in connection with FIG. 7, slots having multiple symbol types (e.g., slots 615g and 615n) are considered uplink or flexible slots if they include a number of contiguous OFDM symbols configured as uplink symbols or flexible symbols, respectively.

The slot format for a specific UE 805 may thereafter be reconfigured using one or more semi-static or dynamic messages, as shown by signaling 820 and 825, respectively. That is, in addition to signaling 815, or instead of signaling 815, signaling 820 and/or 825 may be used to provide an indication regarding the set of slots (e.g., slots 615a-615s or slots 720a-720s) indicating a slot format for one or more slots and/or symbols thereof. More particularly, the indication may indicate one or more uplink slots (e.g., slots 720m-720s) to be used for uplink communication, one or more downlink slots (e.g., slots 720a-720h) used for downlink communication, one or more flexible slots (e.g., slot 720k) available for uplink communication or downlink communication, and/or one or more sidelink-specific slots (e.g., slot 720j) available for sidelink communication. Again, slots containing more than one type of symbol following signaling 820 and/or 825 (e.g., slots 720i and 720l) may be considered an uplink slot, a flexible slot, or a sidelink-specific slot if they include a number of contiguous OFDM symbols configured as uplink symbols, flexible symbols, or sidelink-specific symbols, respectively.

For example, the base station 810 may provide an indication as part of a dedicated configuration parameter (e.g., an RRC parameter tdd-UL-DL-ConfigurationDedicated) to the UE 805 via RRC signaling 820. In some aspects, this dedicated parameter may be sent to one UE 805 (as opposed to all UEs within a cell) and may be used to reconfigure the slot format of the frame structure for the UE 805. For example, the RRC signaling 820 may be used to reconfigure one or more of the flexible slots or symbols as uplink, downlink, and/or sidelink-specific slots or symbols. For example, the RRC signaling 820 may provide an indication indicating that at least one flexible slot (e.g., slot 615m), of the set of slots (e.g., slots 615a-615s), has been modified to become at least one uplink slot (e.g., slot 720m) available for uplink communication. As used herein, “reconfigured uplink slot” is used to refer to a slot that was initially configured to be a flexible slot by a common configuration parameter but which has been reconfigured to be an uplink slot. Alternatively, or additionally, the RRC signaling 820 may provide an indication indicating that that at least one flexible slot (e.g., at least one of slots 615g-615n), of the set of slots (e.g., slots 615a-615s), has been modified to become at least one sidelink-specific slot (e.g., slot 720j) specifically available for sidelink communication.

Moreover, in some aspects the base station 810 may further reconfigure the slot format of the UE 805 frame structure via one or more dynamic messages. This is conceptually illustrated in FIG. 8 via the downlink control information (DCI) signaling 825. The DCI signaling 825 may include a dynamic parameter indicating that one or more slots of the UE 805 frame structure should be reconfigured. In some aspects, the DCI may have a format associated with indication of a slot format. For example, the DCI may use DCI Format 2_0, which includes a parameter notifying one or more UEs 805 of a slot format to be used for a transmission timeline. In some aspects, the DCI signaling 825 may provide an indication indicating that at least one flexible slot (e.g., slot 615m), of the set of slots (e.g., slots 615a-615s), has been modified to become at least one uplink slot (e.g., slot 720m) available for uplink communication. Alternatively, or additionally, the DCI signaling 820 may provide an indication indicating that that at least one flexible slot (e.g., at least one of slots 615g-615n), of the set of slots (e.g., slots 615a-615s), has been modified to become at least one sidelink-specific slot (e.g., slot 720j) specifically available for sidelink communication.

The base station 810 may also provide a sidelink resource pool configuration to the UE 805 via RRC signaling 830 or similar signaling. Again, a sidelink resource pool is a set of resources configured for (e.g., assigned for) sidelink communication. The base station 810 may provide, to the UE 805, a configuration of a subset of the potential resources available for sidelink communication that the UE 805 may use for sidelink communication. In some aspects, the sidelink resource pool configuration may be referred to as a configuration of a resource pool.

In some aspects, the configuration of the resource pool includes one more uplink slots, one or more reconfigured uplink slots, one or more flexible slots, and/or one or more sidelink-specific slots. For example, the resource pool is permitted to include slots that include a number of contiguous OFDM symbols configured as uplink symbols, flexible symbols, or sidelink-specific symbols via one of the configuration parameters provided in the RRC signaling 815, the RRC signaling 820, and/or the DCI signaling 825. That is, the resource pool may include slots including Y-th, (Y+1)-th, ..., (Y+X-1)-th OFDM symbols configured as uplink symbols, flexible symbols, or sidelink-specific symbols, where Y refers to a configured sidelink start symbol parameter (e.g., sl-StartSymbol) and X refers to a sidelink length symbol parameter (e.g., sl-LengthSymbol). In this regard, sl-StartSymbol refers to the symbol index of the first symbol of a number of consecutive symbols, defined by sl-LengthSymbol, configured for sidelink communication. Thus, the resource pool is permitted to include slots that include a number of contiguous OFDM symbols configured as uplink symbols by other configuration parameters in addition to the common configuration parameter, such as one or more of the configuration parameters provided in the RRC signaling 815, the RRC signaling 820, and/or the DCI signaling 825 (e.g., reconfigured uplink slots) in addition to any commonly configured or reconfigured flexible slots or sidelink-specific slots. Permitting the resource pool to include reconfigured uplink slots, flexible slots, and sidelink-specific slots improves flexibility of resource pool configuration relative to if the resource pool was only permitted to include uplink slots configured as uplink slots by the common configuration parameter.

According to some aspects of the present disclosure, a subset of the potentially available slots is selectively chosen for inclusion in the sidelink resource pool. More particularly, the configuration of the resource pool provided by the base station 810 to the UE 805 via RRC signaling 830 or similar may indicate a resource pool that includes less than all of the resources potentially available for inclusion in the resource pool. For example, according to some aspects, the base station 810 may configure the sidelink resource pool to include only a subset of slots that were newly added to the second group of resources 715 in FIG. 7. Put another way, in some aspects, the resource pool includes only one or more slots that are included in the second group of resources 715 and not in the first group of resources 710. This would include one or more of slots 720i-720n and would exclude slots 615o-615s. Inclusion of the one or more slots (e.g., one or more of slots 720i-720n) in the resource pool may be based at least in part on a bitmap indicating the one or more slots (e.g., one or more of slots 720i-720n). The bitmap and/or other configuration indicating the selection may be provided from the base station 810 to the UE 805 using any desired signaling, such as the signaling described in connection with FIG. 8 (e.g., signaling 815, 820, 825, or 830), medium access control (MAC) control element (CE) signaling, or other signaling.

Limiting the resources included in the sidelink resource pool to the ones included in the second group of resources 715 but not in the first group of resources 710 may beneficially maintain backward compatibility of the aspects described herein. Namely, and as described above, for traditional sidelink resource allocation, only slots that are commonly configured uplink slots (i.e., commonly configured slots including a contiguous number of uplink symbols) may be included in the sidelink resource pool. Thus, adding the new potential sidelink resources (e.g., resources included in the second group of resources 715 but not the first group of resources 710) to the sidelink resource pool may cause a sidelink slot index mismatch between a first UE with new sidelink resources included in the sidelink resource pool and a second, legacy UE that is unable to add the new sidelink resources to the sidelink resource pool. Including a resource pool index having, for example, a first resource pool including only original sidelink resources (e.g., resources chosen from only the first group of resources 710) and a second resource pool including only new potential sidelink resources (e.g., resources included in the second group of resources 715 but not the first group of resources 710) avoids ambiguity among the various UEs because reserved resources will not be within two competing resource pools. Instead, any legacy UEs incapable of utilizing the new sidelink resources will simply use the first resource pool.

In some aspects, certain slots contained within the sidelink resource pool may be used for SCI, such as for communicating a first stage (e.g., SCI-1) block of SCI or similar. However, certain UEs may not be able to monitor for a PDCCH and SCI simultaneously. Thus, according to some aspects, certain resources (e.g., slots) are only included in the sidelink resource pool if the symbols within the slot to be used for SCI are indicated as uplink (e.g., “UL”) or sidelink-specific (“S”) symbols, and are not included in the sidelink resource pool if the symbols within the slot to be used for SCI are indicated as flexible (e.g., “F”) symbols, which may potentially be used for PDCCH (since the PDCCH is a downlink communication and flexible symbols can be used for sidelink communications or downlink communications according to the techniques described herein). More particularly, in some aspects, when at least one flexible slot, of the set of slots, includes one or more symbols that are available for SCI, the indication may indicate that the one or more symbols that are available for SCI are only available for one of uplink communication (e.g., a “UL” symbol) or sidelink communication (e.g., a “S” symbol). By excluding slots from the sidelink resource pool that include symbols indicated as flexible in a location to be used for SCI, there is no risk that a UE will miss a PDCCH message while monitoring for a SCI message or vice versa.

In some aspects, including flexible slots in the sidelink resource pool may result in a UE that is scheduled to simultaneously transmit and/or receive sidelink information and uplink or downlink information in a configured flexible symbol. Put another way, the scheduled sidelink communication may overlap with the scheduled uplink or downlink communication. However, the UE may not be capable of performing such simultaneous sidelink and uplink or downlink communication. Accordingly, in some aspects, a UE will perform only one of the sidelink communication or the uplink or downlink communication according to a communication priority of the respective communications. For example, in some aspects, the UE will determine whether a communication priority of the sidelink communication is higher than a communication priority of the uplink or downlink communication that overlaps with the sidelink communication, and the UE will perform sidelink communication based at least in part on the communication priority of the sidelink communication being higher than the communication priority of the uplink or downlink communication.

In some aspects, the priority may be indicated by a parameter provided in a priority field or similar parameter included in the sidelink communication and/or the uplink or downlink communication. In such aspects, the UE may perform the communication having the higher priority parameter. Additionally, or alternatively, the UE may determine that certain physical channel types (e.g., “PHY-channel”) and/or signal types (e.g., “PHY-signal”) have a higher priority than other physical channel types and/or physical signal types, and may perform the communication having the higher priority physical channel type and/or physical signal type. For example, a physical control channel may be prioritized over a physical shared channel. As another example, a particular type of reference signal may be prioritized over a physical shared channel. Additionally, or alternatively, the UE may determine that a semi-static symbol assignment (e.g., one set by RRC signaling, such as semi-persistent scheduling or a configured grant) has a higher or lower priority than a dynamic symbol assignment (e.g., one set by DCI or SCI signaling), and may perform the communication having the higher priority assignment type. Additionally, or alternatively, the UE may determine the priority of the overlapping communications based at least in part on a combination of two or more of the above-described priority determinations (e.g., as set by a priority field, based at least in part on the physical channel type and/or physical signal type, and/or based at least in part on the assignment type).

Although the signaling shown in FIG. 8 includes separate arrows for ease of description, one or more of the signaling may be included in the same message or communication from the base station 810 to the UE 805. That is, in some aspects, two or more of the depicted signaling 815, 820, 825, 830 could be included in a common RRC signaling message or other message. For example, an indication and/or configuration including a common configuration parameter, a dedicated configuration parameter, and/or a sidelink resource pool configuration may be provided in the same RRC message or similar message. Moreover, in some aspects one or more of the depicted signaling 815, 820, 825, 830 could be absent from a signaling scheme between the base station 810 and the UE 805 without departing from the scope of the disclosure. Once the UE 805 has received an indication of each slot format and/or a configuration of the sidelink resource pool to be used for sidelink communication, the UE 805 may perform a sidelink communication with one or more other UEs in accordance with the configuration, such as by using the resources in the sidelink resource pool, as indicated by reference numeral 835.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with sidelink communication in a flexible slot.

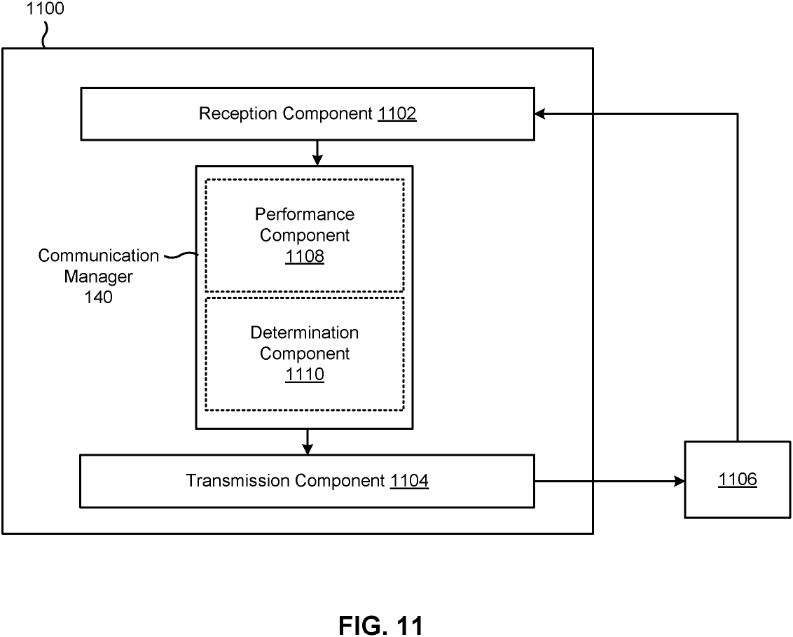

As shown in FIG. 9, in some aspects, process 900 may include receiving an indication regarding a set of slots, wherein the indication indicates one or more flexible slots, of the set of slots, that are available for both downlink communication and uplink communication (block 910). For example, the UE 120 (e.g., using communication manager 140 and/or reception component 1102, depicted in FIG. 11) may receive an indication regarding a set of slots, wherein the indication indicates one or more flexible slots, of the set of slots, that are available for both downlink communication and uplink communication, as described above.

As further shown in FIG. 9, in some aspects, process 900 may include receiving a configuration of a resource pool including the one or more flexible slots (block 920). For example, the UE 120 (e.g., using communication manager 140 and/or reception component 1102, depicted in FIG. 11) may receive a configuration of a resource pool including the one or more flexible slots, as described above.

As further shown in FIG. 9, in some aspects, process 900 may include performing a sidelink communication in accordance with the configuration (block 930). For example, the UE (e.g., using communication manager 140 and/or performance component 1108, depicted in FIG. 11) may perform a sidelink communication in accordance with the configuration, as described above.

Process 900 may include additional aspects, such as any single aspect or any combination of aspects described below and/or in connection with one or more other processes described elsewhere herein.

In a first aspect, the indication is indicated using a dedicated configuration parameter included in a radio resource control (RRC) message.

In a second aspect, the indication is included in a downlink control information (DCI) message.

In a third aspect, the indication is indicated using a common configuration parameter included in a radio resource control (RRC) message.

In a fourth aspect, alone or in combination with one or more of the first through third aspects, the indication further indicates that at least one flexible slot, of the set of slots, has been modified to become at least one uplink slot available for uplink communication, wherein the resource pool further includes the at least one uplink slot.

In a fifth aspect, alone or in combination with one or more of the first through fourth aspects, the indication further indicates one or more sidelink-specific slots, of the set of slots, that are available for sidelink communication, and wherein the resource pool further includes the one or more sidelink-specific slots.

In a sixth aspect, alone or in combination with one or more of the second and fourth through fifth aspects, the indication is included in a downlink control information (DCI) message.

In a seventh aspect, alone or in combination with one or more of the first through sixth aspects, each of the one or more flexible slots includes at least a number of contiguous orthogonal frequency-division multiplexing (OFDM) symbols indicated as flexible.

In an eighth aspect, alone or in combination with one or more of the first through third and sixth through seventh aspects, the resource pool includes only the one or more flexible slots.

In a ninth aspect, alone or in combination with one or more of the first through eighth aspects, inclusion of the one or more flexible slots in the resource pool is based at least in part on a bitmap indicating the one or more flexible slots.

In a tenth aspect, alone or in combination with one or more of the first through ninth aspects, the configuration is included in at least one of a radio resource control (RRC) configuration message, a medium access control (MAC) message, or a downlink control information (DCI) message.

In an eleventh aspect, alone or in combination with one or more of the first through tenth aspects, at least one flexible slot, of the one or more flexible slots, includes one or more symbols that are available for sidelink control information, and wherein the indication further indicates the one or more symbols as being only available for one of uplink communication or sidelink communication.

In a twelfth aspect, alone or in combination with one or more of the first through eleventh aspects, process 900 may include determining that a communication priority of the sidelink communication is higher than a communication priority of an uplink or downlink communication that overlaps with the sidelink communication, and performing the sidelink communication based at least in part on the communication priority of the sidelink communication being higher than the communication priority of the uplink or downlink communication. For example, the UE 120 (e.g., using communication manager 140 and/or determination component 1110, depicted in FIG. 11) may determine that a communication priority of the sidelink communication is higher than a communication priority of an uplink or downlink communication that overlaps with the sidelink communication, and the UE 120 (e.g., using communication manager 140 and/or performance component 1108, depicted in FIG. 11) may perform the sidelink communication based at least in part on the communication priority of the sidelink communication being higher than the communication priority of the uplink or downlink communication, as described above.

In a thirteenth aspect, alone or in combination with one or more of the first through twelfth aspects, at least one of the communication priority of the sidelink communication and the communication priority of the uplink or downlink communication is indicated by a priority field of at least one of the sidelink communication or the uplink or downlink communication.

In a fourteenth aspect, alone or in combination with one or more of the first through thirteenth aspects, determining that the communication priority of the sidelink communication is higher than the communication priority of the uplink or downlink communication is based at least in part on a channel type or a signal type of at least one of the sidelink communication or the uplink or downlink communication.

In a fifteenth aspect, alone or in combination with one or more of the first through fourteenth aspects, determining that the communication priority of the sidelink communication is higher than the communication priority of the uplink or downlink communication is based at least in part on whether at least one of the sidelink communication or the uplink or downlink communication is semi-statically scheduled or dynamically scheduled.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with the present disclosure. Example process 1000 is an example where the base station (e.g., base station 110) performs operations associated with sidelink communication in a flexible slot.

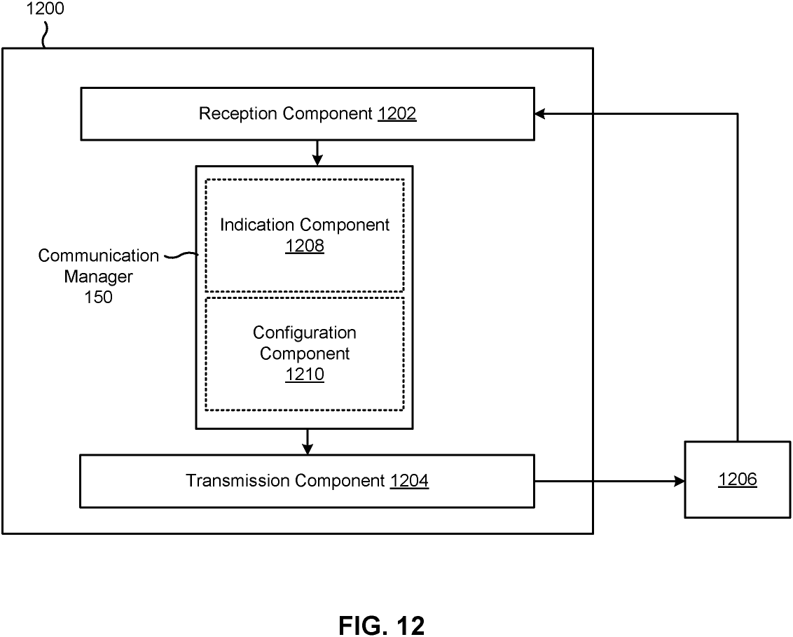

As shown in FIG. 10, in some aspects, process 1000 may include transmitting, to a UE 120, an indication regarding a set of slots, wherein the indication indicates one or more flexible slots, of the set of slots, that are available for both downlink communication and uplink communication (block 1010). For example, the base station (e.g., using communication manager 150 and/or transmission component 1204, depicted in FIG. 12) may transmit, to a UE 120, an indication regarding a set of slots, wherein the indication indicates one or more flexible slots, of the set of slots, that are available for both downlink communication and uplink communication, as described above.

As further shown in FIG. 10, in some aspects, process 1000 may include transmitting, to the UE 120, a configuration of a resource pool including the one or more flexible slots, the resource pool identifying resources available for use by the UE to perform a sidelink communication (block 1020). For example, the base station (e.g., using communication manager 150 and/or transmission component 1204, depicted in FIG. 12) may transmit, to the UE 120, a configuration of a resource pool including the one or more flexible slots, the resource pool identifying resources available for use by the UE 120 to perform a sidelink communication, as described above.

Process 1000 may include additional aspects, such as any single aspect or any combination of aspects described below and/or in connection with one or more other processes described elsewhere herein.

In a first aspect, the indication is indicated using a dedicated configuration parameter included in a radio resource control (RRC) message.

In a second aspect, the indication is included in a downlink control information (DCI) message.

In a third aspect, the indication is indicated using a common configuration parameter included in a radio resource control (RRC) message.

In a fourth aspect, alone or in combination with one or more of the first through third aspects, the indication further indicates that at least one flexible slot, of the set of slots, has been modified to become at least one uplink slot available for uplink communication, wherein the resource pool further includes the at least one uplink slot.

In a fifth aspect, alone or in combination with one or more of the first through fourth aspects, the indication further indicates one or more sidelink-specific slots, of the set of slots, that are available for sidelink communication, and wherein the resource pool further includes the one or more sidelink-specific slots.

In a sixth aspect, alone or in combination with one or more of the second and fourth through fifth aspects, the indication is included in a downlink control information (DCI) message.

In a seventh aspect, alone or in combination with one or more of the first through sixth aspects, each of the one or more flexible slots includes at least a number of contiguous orthogonal frequency-division multiplexing (OFDM) symbols indicated as flexible.

In an eighth aspect, alone or in combination with one or more of the first through third and sixth through seventh aspects, the resource pool includes only the one or more flexible slots.

In a ninth aspect, alone or in combination with one or more of the first through eighth aspects, process 1000 includes transmitting, to the UE 120, a bitmap indicating the one or more flexible slots.

In a tenth aspect, alone or in combination with one or more of the first through ninth aspects, the configuration is included in at least one of a radio resource control (RRC) configuration message, a medium access control (MAC) message, or a downlink control information (DCI) message.

In an eleventh aspect, alone or in combination with one or more of the first through tenth aspects, at least one flexible slot, of the one or more flexible slots, includes one or more symbols that are available for sidelink control information, and wherein the indication further indicates the one or more symbols as being only available for one of uplink communication or sidelink communication.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE 120, or a UE 120 may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE 120, a base station 110, or another wireless communication device) using the reception component 1102 and the transmission component 1104. As further shown, the apparatus 1100 may include the communication manager 140. The communication manager 140 may include one or more of a performance component 1108, or a determination component 1110, among other examples.

In some aspects, the apparatus 1100 may be configured to perform one or more operations described herein in connection with FIGS. 7-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE 120 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE 120 described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE 120 described in connection with FIG. 2. In some aspects, the transmission component 1104 may be co-located with the reception component 1102 in a transceiver.

The reception component 1102 may receive an indication regarding a set of slots, wherein the indication indicates one or more flexible slots, of the set of slots, that are available for both downlink communication and uplink communication. The reception component 1102 may receive a configuration of a resource pool including the one or more flexible slots. The performance component 1108, the reception component 1102, or the transmission component 1104 may perform a sidelink communication in accordance with the configuration.

The determination component 1110 may determine that a communication priority of the sidelink communication is higher than a communication priority of an uplink or downlink communication that overlaps with the sidelink communication.

The performance component 1108 may perform the sidelink communication based at least in part on the communication priority of the sidelink communication being higher than the communication priority of the uplink or downlink communication.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a base station 110, or a base station 110 may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE 120, a base station 110, or another wireless communication device) using the reception component 1202 and the transmission component 1204. As further shown, the apparatus 1200 may include the communication manager 150. The communication manager 150 may include one or more of an indication component 1208, or a configuration component 1210, among other examples.

In some aspects, the apparatus 1200 may be configured to perform one or more operations described herein in connection with FIGS. 7-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the base station 110 described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the base station described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the base station described in connection with FIG. 2. In some aspects, the transmission component 1204 may be co-located with the reception component 1202 in a transceiver.

The transmission component 1204 may transmit, to a UE 120, an indication regarding a set of slots, wherein the indication indicates one or more flexible slots, of the set of slots, that are available for both downlink communication and uplink communication. The transmission component 1204 may transmit, to the UE 120, a configuration of a resource pool including the one or more flexible slots, the resource pool identifying resources available for use by the UE 120 to perform a sidelink communication.

The transmission component 1204 may transmit, to the UE, a bitmap indicating the one or more flexible slots.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: receiving an indication regarding a set of slots, wherein the indication indicates one or more flexible slots, of the set of slots, that are available for both downlink communication and uplink communication; receiving a configuration of a resource pool including the one or more flexible slots; and performing a sidelink communication in accordance with the configuration.

Aspect 2: The method of Aspect 1, wherein the indication is indicated using a dedicated configuration parameter included in a radio resource control (RRC) message.

Aspect 3: The method of Aspect 1, wherein the indication is included in a downlink control information (DCI) message.

Aspect 4: The method of any of Aspects 1 and 3, wherein the indication is indicated using a common configuration parameter included in a radio resource control (RRC) message.

Aspect 5: The method of any of Aspects 1-4, wherein the indication further indicates that at least one flexible slot, of the set of slots, has been modified to become at least one uplink slot available for uplink communication, wherein the resource pool further includes the at least one uplink slot.

Aspect 6: The method of any of Aspects 1-5, wherein the indication further indicates one or more sidelink-specific slots, of the set of slots, that are available for sidelink communication, and wherein the resource pool further includes the one or more sidelink-specific slots.

Aspect 7: The method of Aspect 6, wherein the indication is included in a downlink control information (DCI) message.

Aspect 8: The method of any of Aspects 1-6, wherein each of the one or more flexible slots includes at least a number of contiguous orthogonal frequency-division multiplexing (OFDM) symbols indicated as flexible.

Aspect 9: The method of any of Aspects 1-4 and 7-8, wherein the resource pool includes only the one or more flexible slots.

Aspect 10: The method of any of Aspects 1-9, wherein inclusion of the one or more flexible slots in the resource pool is based at least in part on a bitmap indicating the one or more flexible slots.

Aspect 11: The method of any of Aspects 1-10, wherein the configuration is included in at least one of a radio resource control (RRC) configuration message, a medium access control (MAC) message, or a downlink control information (DCI) message.

Aspect 12: The method of any of Aspects 1-11, wherein at least one flexible slot, of the one or more flexible slots, includes one or more symbols that are available for sidelink control information, and wherein the indication further indicates the one or more symbols as being only available for one of uplink communication or sidelink communication.

Aspect 13: The method of any of Aspects 1-12, further comprising: determining that a communication priority of the sidelink communication is higher than a communication priority of an uplink or downlink communication that overlaps with the sidelink communication; and performing the sidelink communication based at least in part on the communication priority of the sidelink communication being higher than the communication priority of the uplink or downlink communication.

Aspect 14: The method of Aspect 13, wherein at least one of the communication priority of the sidelink communication and the communication priority of the uplink or downlink communication is indicated by a priority field of at least one of the sidelink communication or the uplink or downlink communication.

Aspect 15: The method of Aspect 13, wherein determining that the communication priority of the sidelink communication is higher than the communication priority of the uplink or downlink communication is based at least in part on a channel type or a signal type of at least one of the sidelink communication or the uplink or downlink communication.

Aspect 16: The method of Aspect 13, wherein determining that the communication priority of the sidelink communication is higher than the communication priority of the uplink or downlink communication is based at least in part on whether at least one of the sidelink communication or the uplink or downlink communication is semi-statically scheduled or dynamically scheduled.

Aspect 17: A method of wireless communication performed by a base station, comprising: transmitting, to a UE, an indication regarding a set of slots, wherein the indication indicates one or more flexible slots, of the set of slots, that are available for both downlink communication and uplink communication; and transmitting, to the UE, a configuration of a resource pool including the one or more flexible slots, the resource pool identifying resources available for use by the UE to perform a sidelink communication.

Aspect 18: The method of Aspect 17, wherein the indication is indicated using a dedicated configuration parameter included in a radio resource control (RRC) message.

Aspect 19: The method of Aspect 17, wherein the indication is included in a downlink control information (DCI) message.

Aspect 20: The method of Aspect 17, wherein the indication is indicated using a common configuration parameter included in a radio resource control (RRC) message.

Aspect 21: The method of any of Aspects 17-20, wherein the indication further indicates that at least one flexible slot, of the set of slots, has been modified to become at least one uplink slot available for uplink communication, wherein the resource pool further includes the at least one uplink slot.

Aspect 22: The method of any of Aspects 17-21, wherein the indication further indicates one or more sidelink-specific slots, of the set of slots, that are available for sidelink communication, and wherein the resource pool further includes the one or more sidelink-specific slots.

Aspect 23: The method of Aspect 22, wherein the indication is included in a downlink control information (DCI) message.

Aspect 24: The method of any of Aspects 17-23, wherein each of the one or more flexible slots includes at least a number of contiguous orthogonal frequency-division multiplexing (OFDM) symbols indicated as flexible.

Aspect 25: The method of any of Aspects 17-20 and 23-24, wherein the resource pool includes only the one or more flexible slots.

Aspect 26: The method of any of Aspects 17-25 further comprising transmitting, to the UE, a bitmap indicating the one or more flexible slots.

Aspect 27: The method of any of Aspects 17-26, wherein the configuration is included in at least one of a radio resource control (RRC) configuration message, a medium access control (MAC) message, or a downlink control information (DCI) message.

Aspect 28: The method of any of Aspects 17-27, wherein at least one flexible slot, of the one or more flexible slots, includes one or more symbols that are available for sidelink control information, and wherein the indication further indicates the one or more symbols as being only available for one of uplink communication or sidelink communication.

Aspect 29: An apparatus for wireless communication at a device, comprising a processor; memory coupled with the processor; and instructions stored in the memory and executable by the processor to cause the apparatus to perform the method of one or more of Aspects 1-16.

Aspect 30: A device for wireless communication, comprising a memory and one or more processors coupled to the memory, the one or more processors configured to perform the method of one or more of Aspects 1-16.

Aspect 31: An apparatus for wireless communication, comprising at least one means for performing the method of one or more of Aspects 1-16.

Aspect 32: A non-transitory computer-readable medium storing code for wireless communication, the code comprising instructions executable by a processor to perform the method of one or more of Aspects 1-16.

Aspect 33: A non-transitory computer-readable medium storing a set of instructions for wireless communication, the set of instructions comprising one or more instructions that, when executed by one or more processors of a device, cause the device to perform the method of one or more of Aspects 1-16.

Aspect 34: An apparatus for wireless communication at a device, comprising a processor; memory coupled with the processor; and instructions stored in the memory and executable by the processor to cause the apparatus to perform the method of one or more of Aspects 17-28.

Aspect 35: A device for wireless communication, comprising a memory and one or more processors coupled to the memory, the one or more processors configured to perform the method of one or more of Aspects 17-28.

Aspect 36: An apparatus for wireless communication, comprising at least one means for performing the method of one or more of Aspects 17-28.

Aspect 37: A non-transitory computer-readable medium storing code for wireless communication, the code comprising instructions executable by a processor to perform the method of one or more of Aspects 17-28.

Aspect 38: A non-transitory computer-readable medium storing a set of instructions for wireless communication, the set of instructions comprising one or more instructions that, when executed by one or more processors of a device, cause the device to perform the method of one or more of Aspects 17-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive an indication regarding a set of slots, wherein the indication indicates one or more flexible slots, of the set of slots, that are available for both downlink communication and uplink communication;
receive a configuration of a resource pool including the one or more flexible slots; and
perform a sidelink communication in accordance with the configuration.

2. The apparatus of claim 1, wherein the indication is indicated using a dedicated configuration parameter included in a radio resource control (RRC) message.

3. The apparatus of claim 1, wherein the indication is included in a downlink control information (DCI) message.

4. The apparatus of claim 1, wherein the indication is indicated using a common configuration parameter included in a radio resource control (RRC) message.

5. The apparatus of claim 1, wherein the indication further indicates that at least one flexible slot, of the set of slots, has been modified to become at least one uplink slot available for uplink communication, wherein the resource pool further includes the at least one uplink slot.

6. The apparatus of claim 1, wherein the indication further indicates one or more sidelink-specific slots, of the set of slots, that are available for sidelink communication, and wherein the resource pool further includes the one or more sidelink-specific slots.

7. The apparatus of claim 6, wherein the indication is included in a downlink control information (DCI) message.

8. The apparatus of claim 1, wherein each of the one or more flexible slots includes at least a number of contiguous orthogonal frequency-division multiplexing (OFDM) symbols indicated as flexible.

9. The apparatus of claim 1, wherein the resource pool includes only the one or more flexible slots.

10. The apparatus of claim 1, wherein inclusion of the one or more flexible slots in the resource pool is based at least in part on a bitmap indicating the one or more flexible slots.

11. The apparatus of claim 1, wherein the configuration is included in at least one of a radio resource control (RRC) configuration message, a medium access control (MAC) message, or a downlink control information (DCI) message.

12. The apparatus of claim 1, wherein at least one flexible slot, of the one or more flexible slots, includes one or more symbols that are available for sidelink control information, and wherein the indication further indicates the one or more symbols as being only available for one of uplink communication or sidelink communication.

13. The apparatus of claim 1, wherein the one or more processors are further configured to:
determine that a communication priority of the sidelink communication is higher than a communication priority of an uplink or downlink communication that overlaps with the sidelink communication; and
perform the sidelink communication based at least in part on the communication priority of the sidelink communication being higher than the communication priority of the uplink or downlink communication.

14. The apparatus of claim 13, wherein at least one of the communication priority of the sidelink communication and the communication priority of the uplink or downlink communication is indicated by a priority field of at least one of the sidelink communication or the uplink or downlink communication.

15. The apparatus of claim 13, wherein determining that the communication priority of the sidelink communication is higher than the communication priority of the uplink or downlink communication is based at least in part on a channel type or a signal type of at least one of the sidelink communication or the uplink or downlink communication.

16. The apparatus of claim 13, wherein determining that the communication priority of the sidelink communication is higher than the communication priority of the uplink or downlink communication is based at least in part on whether at least one of the sidelink communication or the uplink or downlink communication is semi-statically scheduled or dynamically scheduled.

17. An apparatus for wireless communication at a base station, comprising:
a memory; and
one or more processors, coupled to the memory, configured to:
transmit, to a user equipment (UE), an indication regarding a set of slots, wherein the indication indicates one or more flexible slots, of the set of slots, that are available for both downlink communication and uplink communication; and
transmit, to the UE, a configuration of a resource pool including the one or more flexible slots, the resource pool identifying resources available for use by the UE to perform a sidelink communication.

18. The apparatus of claim 17, wherein the indication is indicated using a dedicated configuration parameter included in a radio resource control (RRC) message.

19. The apparatus of claim 17, wherein the indication is included in a downlink control information (DCI) message.

20. The apparatus of claim 17, wherein the indication is indicated using a common configuration parameter included in a radio resource control (RRC) message.

21. The apparatus of claim 17, wherein the indication further indicates that at least one flexible slot, of the set of slots, has been modified to become at least one uplink slot available for uplink communication, wherein the resource pool further includes the at least one uplink slot.

22. The apparatus of claim 17, wherein the indication further indicates one or more sidelink-specific slots, of the set of slots, that are available for sidelink communication, and wherein the resource pool further includes the one or more sidelink-specific slots.

23. The apparatus of claim 17, wherein each of the one or more flexible slots includes at least a number of contiguous orthogonal frequency-division multiplexing (OFDM) symbols indicated as flexible.

24. The apparatus of claim 17, wherein at least one flexible slot, of the one or more flexible slots, includes one or more symbols that are available for sidelink control information, and wherein the indication further indicates the one or more symbols as being only available for one of uplink communication or sidelink communication.

25. A method of wireless communication performed by a user equipment (UE), comprising:
receiving an indication regarding a set of slots, wherein the indication indicates one or more flexible slots, of the set of slots, that are available for both downlink communication and uplink communication;
receiving a configuration of a resource pool including the one or more flexible slots; and
performing a sidelink communication in accordance with the configuration.

26. The method of claim 25, wherein the indication is indicated using a dedicated configuration parameter included in a radio resource control (RRC) message.

27. The method of claim 25, wherein the indication is included in a downlink control information (DCI) message.

28. The method of claim 25, wherein the indication further indicates that at least one flexible slot, of the set of slots, has been modified to become at least one uplink slot available for uplink communication, wherein the resource pool further includes the at least one uplink slot.

29. A method of wireless communication performed by a base station, comprising:
transmitting, to a user equipment (UE), an indication regarding a set of slots, wherein the indication indicates one or more flexible slots, of the set of slots, that are available for both downlink communication and uplink communication; and
transmitting, to the UE, a configuration of a resource pool including the one or more flexible slots, the resource pool identifying resources available for use by the UE to perform a sidelink communication.

30. The method of claim 29, wherein the indication further indicates that at least one flexible slot, of the set of slots, has been modified to become at least one uplink slot available for uplink communication, wherein the resource pool further includes the at least one uplink slot.
